(19) United States
(12) Patent Application Publication
(10) Pub. No.: US 2025/0079621 A1
(43) Pub. Date: Mar. 6, 2025

(54) TRACTION BATTERY PACK HEADER

(71) Applicant: Ford Global Technologies, LLC, Dearborn, MI (US)

(72) Inventors: Kevin A. Montgomery, Royal Oak, MI (US); Steve Droste, Canton, MI (US); Hari Krishna Addanki, Novi, MI (US)

(21) Appl. No.: 18/461,701

(22) Filed: Sep. 6, 2023

(51) Int. Cl. H01M 50/296; H01M 50/262; H01M 50/505

(52) U.S. Cl. CPC H01M 50/296; H01M 50/262; H01M 50/505; H01M 50/249; H01M 2220/20

(57) ABSTRACT

A battery pack assembly, including: a header configured to transition from an uninstalled position relative to an enclosure to an installed position relative to the enclosure. The header in the installed position disposed over an opening in the enclosure. The header in the installed position receiving a portion of a busbar when the header is in the installed position.

### TECHNICAL FIELD

This disclosure relates generally to a header for a traction battery pack and, more particularly, to a header that can be accessed without opening an enclosure of the traction battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A battery pack can power the electric machines. The battery pack of an electrified vehicle can include groups of battery cells.

### SUMMARY

In some aspects, the techniques described herein relate to a battery pack assembly, including: a header configured to transition from an uninstalled position relative to an enclosure to an installed position relative to the enclosure, the header in the installed position disposed over an opening in the enclosure, the header in the installed position receiving a portion of a busbar when the header is in the installed position.

In some aspects, the techniques described herein relate to a battery pack assembly, wherein the busbar extends through the opening from an interior of the enclosure.

In some aspects, the techniques described herein relate to a battery pack assembly, wherein the header is configured to move from the uninstalled position to the installed position without accessing the interior.

In some aspects, the techniques described herein relate to a battery pack assembly, further including at least one mechanical fastener securing the header to the enclosure when the header is in the installed position.

In some aspects, the techniques described herein relate to a battery pack assembly, wherein the opening is in a wall of a tray of the enclosure.

In some aspects, the techniques described herein relate to a battery pack assembly, wherein the busbar is electrically coupled to a battery array held within the enclosure.

In some aspects, the techniques described herein relate to a battery pack assembly, wherein the busbar is press-fit to the header.

In some aspects, the techniques described herein relate to a battery pack assembly, wherein the busbar is snap-fit to the header.

In some aspects, the techniques described herein relate to a battery pack assembly, wherein the busbar is a first busbar, the header in the installed position further receiving a second busbar that extends through the opening from an interior of the enclosure.

In some aspects, the techniques described herein relate to a battery pack assembly, wherein the header is configured to removably engage with an electrical connector to electrically connect at least one component within an interior of the enclosure with at least one component outside the interior of the enclosure.

In some aspects, the techniques described herein relate to a battery pack assembly, further including, the enclosure, a battery array held within an interior area of the enclosure, the busbar extending from the battery array through the opening to the header, and an electrical connector that is engageable with the header to electrically connect the electrical connector to the busbar.

In some aspects, the techniques described herein relate to a battery pack assembly, wherein the busbar extends through the opening to an exterior of the enclosure.

In some aspects, the techniques described herein relate to a battery pack assembly, wherein the enclosure includes an enclosure lid secured to an enclosure tray, wherein the header is configured to transition from the installed position to the uninstalled position without separating the enclosure lid from the enclosure tray.

In some aspects, the techniques described herein relate to a battery pack connection method, including: securing a header to an enclosure such that the header is disposed over an opening in the enclosure and the header receives a portion of a busbar that extends from an interior of the enclosure through the opening to an exterior of the enclosure; and coupling a connector to the header to electrically couple a component outside the interior to the enclosure.

In some aspects, the techniques described herein relate to a battery pack connection method, further including securing the header to the enclosure using at least one mechanical fastener.

In some aspects, the techniques described herein relate to a battery pack connection method, wherein the header can be unsecured from the enclosure without accessing the interior.

In some aspects, the techniques described herein relate to a battery pack connection method, wherein the busbar extends through the opening during the securing.

In some aspects, the techniques described herein relate to a battery pack connection method, further including, from the exterior, unsecuring the header from the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective view of the traction battery pack from the electrified vehicle of FIG. 1.

FIG. 3 illustrates an electrical connector moving toward a header of the traction battery pack of FIG. 2.

FIG. 4 illustrates a close-up view of the header in an installed position with an enclosure of the traction battery pack.

FIG. 5 illustrates a closeup view section view of a portion of area of FIG. 4 prior to securing the header in the installed position.

FIG. 6 illustrates a section view at line 6-6 in FIG. 3.

### DETAILED DESCRIPTION

A header can provide an interface for connecting connectors to a battery pack. This disclosure details example exemplary headers that can be accessed and serviced without opening an enclosure of the traction battery pack.

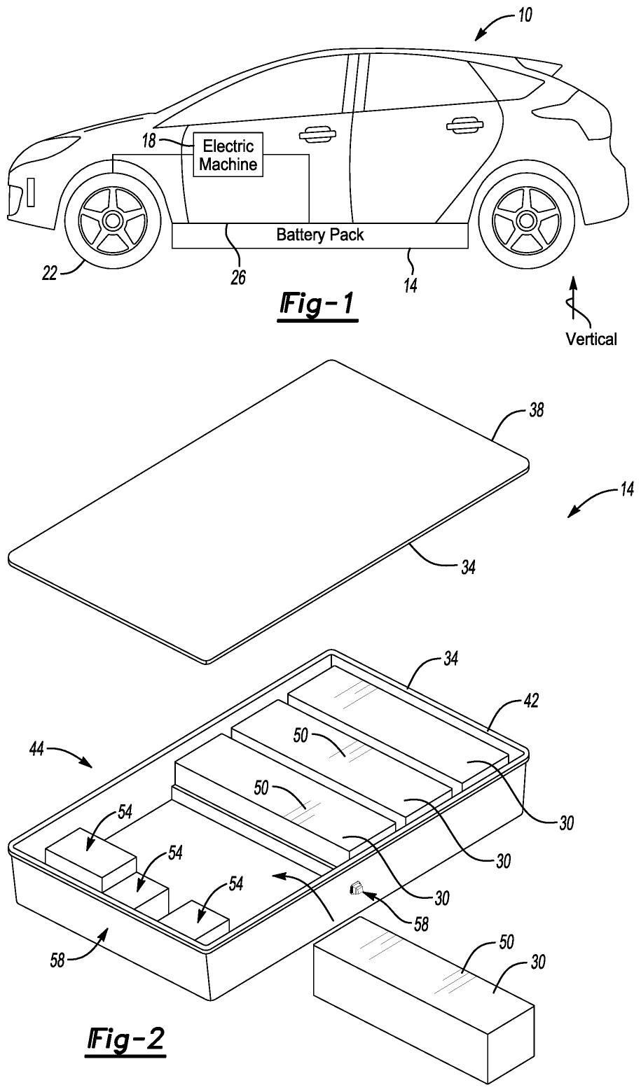

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery arrays 30.

The battery arrays 30 each includes a plurality of battery cells 50 (or simply, “cells”) stacked side-by side relative to each other. The battery cells 50 are for supplying electrical power to various components of the electrified vehicle 10.

Although a specific number of cells 50 and arrays 30 are illustrated in the various figures of this disclosure, the battery pack 14 could include any number of arrays 30 having any number of cells 50. In other words, this disclosure is not limited to the specific configuration shown in FIG. 2.

Other components 54 are housed within the enclosure assembly 34. Examples of the other components 54 can include control modules. In particular, the other components housed within the enclosure assembly 34 can include a Bussed Electrical Center (BEC), a Battery Electronic Control Module (BECM), and a Battery Pack Sensor Module (BPSM).

The battery pack 14 includes a least one header 58 that provides a connection interface for communicating with components of the battery pack 14, powering components of the battery pack 14, sending power outside the battery pack 14, or some combination of these.

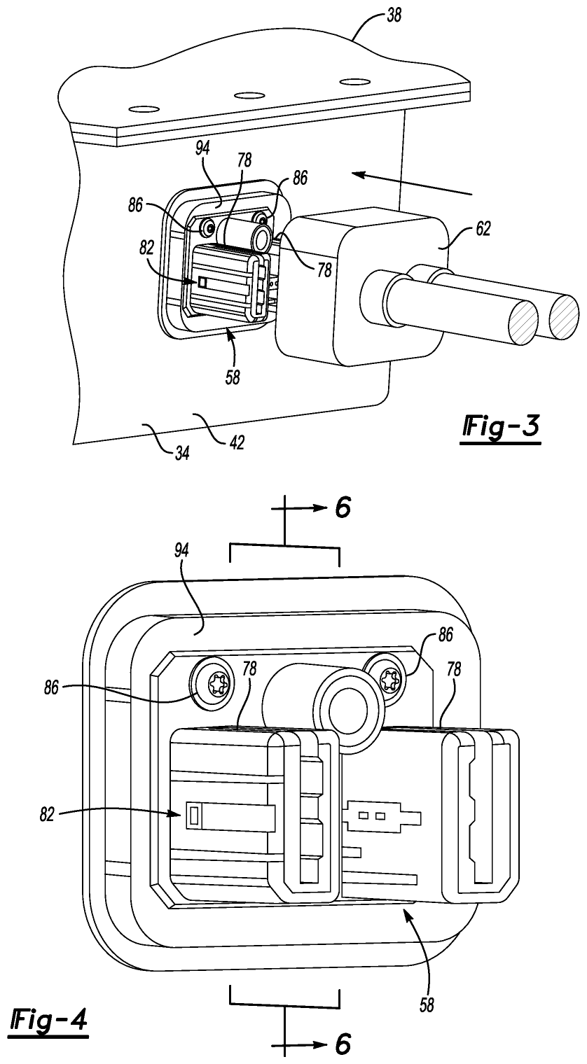

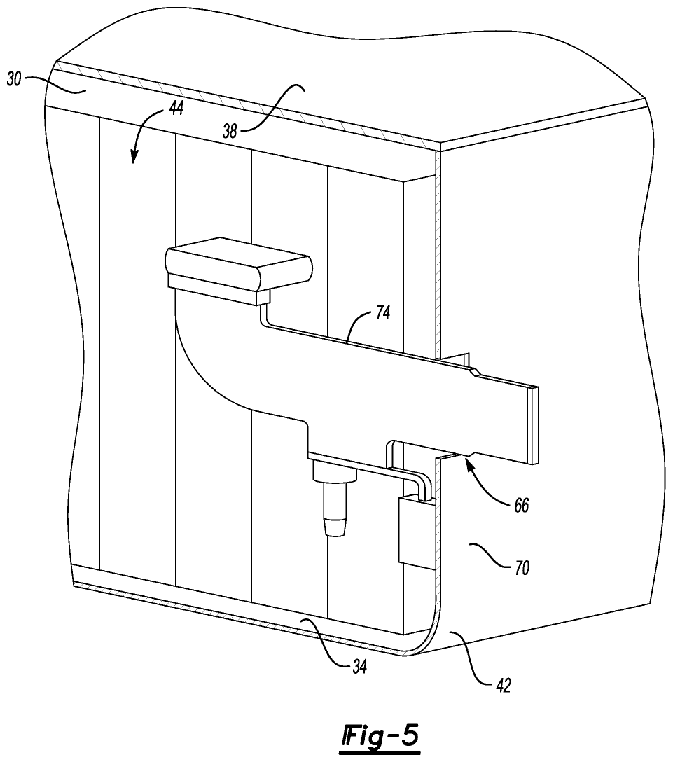

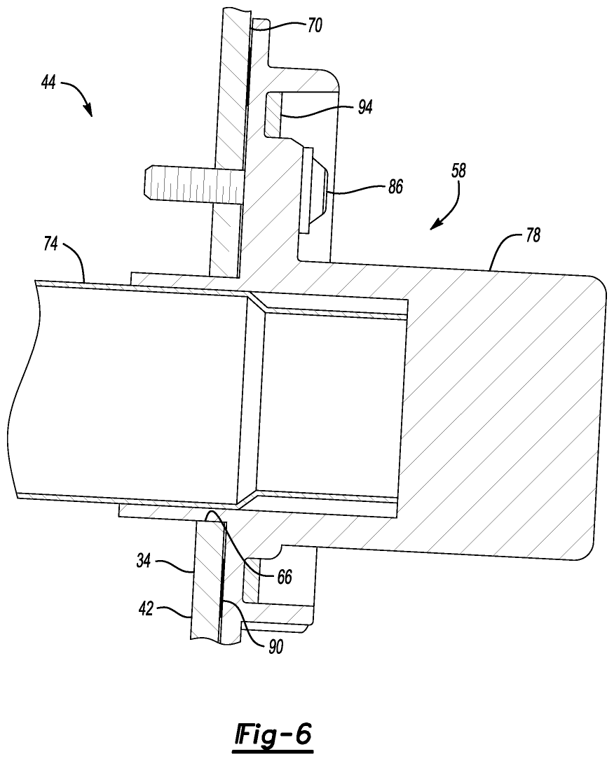

With reference now to FIGS. 3-6 and continued reference to FIGS. 1 and 2, in this example, an electrical connector 62 can connect to the header 58 to electrically couple components that are outside the battery pack 14 to the battery pack 14. In an example, the connector 62 can engage the header 58 to couple the electric machine 18 to the battery pack 14. In particular, the connector 62 can couple the battery pack 14 to a primary or secondary drive unit, or to a charge portion of the vehicle 10.

Notably, the example header 58 can be transitioned back-and-forth between an uninstalled and the installed position while the enclosure cover 38 remains secured to the enclosure tray 42. Thus, if the header 58 requires servicing or replacing, the operations can be carried out without separating the enclosure cover 38 from the enclosure tray 42.

The header 58, in the installed position, is disposed over an opening 66 within the enclosure assembly 34. In this example, the header 58 is secured directly to an exterior surface 70 of the enclosure tray 42, and the opening 66 is within a wall of the enclosure tray 42.

A busbar 74 is part of the battery pack 14. The busbar 74 is electrically connected to the arrays 30 and battery cells 50 within the interior of the enclosure assembly 34.

The busbar 74 extends from the interior area 44 through the opening 66. A portion of the busbar 74 protrudes through the opening 66 to an exterior of the battery pack 14.

In this example, the header 58 includes at least one busbar receptacle 78. As the header 58 is moved to the installed position, portions of the busbars 74 are received within respective busbar receptacles 78 within the header 58.

In the exemplary embodiment, the busbar receptacles 78 include snap-fit features 82. As the portions of the busbars 74 are received within the busbar receptacles 78, the snap-fit features 82 snap-fit the busbars 74 to the busbar receptacles 78. The snap-fit helps to secure and align the busbar 74 within the header 58. The portions of the busbar 74 received within the busbar receptacles 78 can instead or additionally be press-fit within the busbar receptacles 78.

After the busbars 74 are received within the busbar receptacles 78, the header 58 is secured to the enclosure assembly 34. In this example, the header 58 is secured using a plurality of mechanical fasteners 86. In another example, the header 58 is instead or additionally snap-fit to the enclosure assembly 34.

A first seal 90 is sandwiched between the header 58 and the enclosure assembly 34 to seal interfaces between the header 58 and the enclosure assembly 34.

After the header 58 is secured to the enclosure assembly 34, the connector 62 can selectively engage the header 58 to electrically connect components outside the battery pack 14 to the battery pack 14. The connector 62 could be engaged with the header 58 in various ways, including with a lever-action or bolt-on type connection.

A second seal 94 is sandwiched between the header 58 and the connector 62 when the connector 62 engages the header 58. The second seal 94 seals interfaces between the connector 62 and the header 58 when the connector 62 engages the header 58. The second seal 94 also seals off the opening 66 and the fasteners 86 that are “inside” the first seal 90 when the connector 62 is installed to the header 58.

When removing the header 58 is necessary, the connector 62 is first decoupled from the header 58. Next, the fasteners 86 are removed, and the busbars 74 released from the busbar receptacles 78. A service tool may be utilized to release the snap-fit features 82 from the busbars 74. The header 58 can then be moves to an uninstalled position where the header 58 no longer covers the opening 66 in the enclosure assembly 34. The removal of the header 58 notably occurs without requiring any separation of the enclosure cover 38 from the enclosure tray 42.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A battery pack assembly, comprising:
a header configured to transition from an uninstalled position relative to an enclosure to an installed position relative to the enclosure, the header in the installed position disposed over an opening in the enclosure, the header in the installed position receiving a portion of a busbar when the header is in the installed position.

2. The battery pack assembly of claim 1, wherein the busbar extends through the opening from an interior of the enclosure.

3. The battery pack assembly of claim 2, wherein the header is configured to move from the uninstalled position to the installed position without accessing the interior.

4. The battery pack assembly of claim 1, further comprising at least one mechanical fastener securing the header to the enclosure when the header is in the installed position.

5. The battery pack assembly of claim 1, wherein the opening is in a wall of a tray of the enclosure.

6. The battery pack assembly of claim 1, wherein the busbar is electrically coupled to a battery array held within the enclosure.

7. The battery pack assembly of claim 1, wherein the busbar is press-fit to the header.

8. The battery pack assembly of claim 1, wherein the busbar is snap-fit to the header.

9. The battery pack assembly of claim 1, wherein the busbar is a first busbar, the header in the installed position further receiving a second busbar that extends through the opening from an interior of the enclosure.

10. The battery pack assembly of claim 1, wherein the header is configured to removably engage with an electrical connector to electrically connect at least one component within an interior of the enclosure with at least one component outside the interior of the enclosure.

11. The battery pack assembly of claim 1, further comprising,
the enclosure,
a battery array held within an interior area of the enclosure,
the busbar extending from the battery array through the opening to the header, and
an electrical connector that is engageable with the header to electrically connect the electrical connector to the busbar.

12. The battery pack assembly of claim 11, wherein the busbar extends through the opening to an exterior of the enclosure.

13. The battery pack assembly of claim 11, wherein the enclosure includes an enclosure lid secured to an enclosure tray, wherein the header is configured to transition from the installed position to the uninstalled position without separating the enclosure lid from the enclosure tray.

14. A battery pack connection method, comprising:
securing a header to an enclosure such that the header is disposed over an opening in the enclosure and the header receives a portion of a busbar that extends from an interior of the enclosure through the opening to an exterior of the enclosure; and
coupling a connector to the header to electrically couple a component outside the interior to the enclosure.

15. The battery pack connection method of claim 14, further comprising securing the header to the enclosure using at least one mechanical fastener.

16. The battery pack connection method of claim 14, wherein the header can be unsecured from the enclosure without accessing the interior.

17. The battery pack connection method of claim 14, wherein the busbar extends through the opening during the securing.

18. The battery pack connection method of claim 14, further comprising, from the exterior, unsecuring the header from the enclosure.
